(19) United States
(12) Patent Application Publication
(10) Pub. No.: US 2013/0187396 A1
(43) Pub. Date: Jul. 25, 2013

(54) METHOD FOR PRODUCING A MOTOR VEHICLE BENDING CROSS MEMBER AND MOTOR VEHICLE BENDING CROSS MEMBER

(71) Applicants: Franz Ulrich Brockhoff, Bramsche (DE); Stefan Grottke, Rheine (DE); Stefan Schmitz, Bielefeld (DE); Holger Diersmann, Westerkappeln (DE)

(72) Inventors: Franz Ulrich Brockhoff, Bramsche (DE); Stefan Grottke, Rheine (DE); Stefan Schmitz, Bielefeld (DE); Holger Diersmann, Westerkappeln (DE)

(73) Assignee: Benteler Automobiltechnik GmbH, Paderborn (DE)

(21) Appl. No.: 13/556,747

(22) Filed: Jul. 24, 2012

(30) Foreign Application Priority Data
Jul. 26, 2011 (DE) 10 2011 052 153.4

(51) Int. Cl. B60R 19/18

(52) U.S. Cl. CPC B60R 19/18
USPC 293/146; 29/428; 29/505

(57) ABSTRACT

In a method for producing a motor vehicle bending cross member bending a double-U-profile is initially formed from a metal plank. The double-U-profile has two U-shaped longitudinal sections which are connected by a web. The outer legs of the double-U-profile are longer than the inner legs which are connected by the web. The outer legs are formed in a further forming step thereby forming hollow chambers and subsequently joined with the bending cross member preferably in the intermediate region from the inner legs to the web

### CROSS-REFERENCES TO RELATED APPLICATIONS

This application claims the priority of German Patent Application, Serial No. 10 2011 052 153.4, filed Jul. 26, 2011, pursuant to 35 U.S.C. 119(a)-(d), the disclosure of which is incorporated herein by reference.

### BACKGROUND OF THE INVENTION

The present invention relates to a method for producing a motor vehicle bending cross member and a motor vehicle bending cross member.

The following discussion of related art is provided to assist the reader in understanding the advantages of the invention, and is not to be construed as an admission that this related art is prior art to this invention.

Motor vehicle bending cross members are known in many different geometrical configurations namely in one-piece form as well as in multi-piece form and made of steel and aluminum.

Bending cross members are known which are made from roll form profiles and extrusion profiles. These have the disadvantage that additional steps of sawing or respectively, milling or pressing as well as punching of the end sections have to be performed.

It would therefore be desirable and advantageous to provide an efficient method for producing a weight optimized bending cross member which has a double hollow chamber profile and to create a motor vehicle bending cross member which has improved applicability and in particular a more favorable weight.

### SUMMARY OF THE INVENTION

According to one aspect of the present invention, a motor vehicle bending cross member has a double hollow chamber profile and includes two outer hollow chambers, wherein the outer hollow chambers can be connected by a web, wherein the double hollow chamber profile can be configured one-layered, and wherein the outer hollow chambers can be spaced apart by the web.

According to another aspect of the present invention, a method for producing a motor vehicle bending cross member from a metal blank includes the steps of forming the metal blank into a double-U-profile, wherein the double-U-profile have two U-shaped longitudinal sections connected by a web, each of the U-shaped longitudinal sections having outer and inner legs, molding the outer legs of the U-shaped longitudinal sections to thereby form respective hollow chambers of the motor vehicle bending cross member, wherein the hollow chambers extend along a longitudinal direction of the motor vehicle bending cross member, and joining the outer legs to the motor vehicle bending cross member, such that the hollow chambers are spaced apart by the web and the web is configured one layered. For this, the outer longitudinal edges of the formed legs are joined in the joint region at least partially with the bending cross member in particular to the web or in the region of the web. The joining can preferably occur by welding or bonding.

This web has the function to connect the two hollow chambers to one another and to thereby create the double hollow chamber profile, with the hollow chambers being spaced apart by virtue of the web. The two hollow chambers are spaced apart by the width of the web in a targeted manner.

The width of the web can be adjusted to the specification profile that the component has to satisfy. Aspects of this specification profile are for example an improved bending stiffness or a payload-adjusted section modulus or an optimized deformation behavior in the case of a collision.

The forming of the metal blanks occurs in a press mould tool in only two steps or respectively, two tool steps.

Compared to roll formed or press formed double U profiles the load bearing capacity in a plastically deformable region is increased in a closed double O cross member according to the invention.

Particularly advantageously a double-U-profile is formed in the first step of the forming in which the outer legs are longer than the inner legs which are connected to one another via the web. In a further forming step the longer outer legs are then rolled in or respectively, formed and configured to the hollow chambers whereupon the joining with the profile takes place at the joint edges or respectively longitudinal edges of the legs. When rolling in or respectively, forming the outer legs the latter can be supported in a controlled manner, for example by means of a support mandrel.

A bending cross member which has a double-U-profile cross section offers advantageous with regard to manufacturing and also with regard to the component properties.

According to another advantageous feature of the invention, the hollow chambers are configured to have a cross section that varies in longitudinal direction. In this way the installation space specifications and the requirements with regard to strength and bending stiffness of a bending cross member can be taken into account and in addition, weight can be reduced.

According to another advantageous feature of the present invention, the metal blank is cut and/or punched near-net-shape, preferably the provided metal blank corresponds to the layout of the bending cross member to be produced. Before the forming, press cuts, punching, embossments and/or extrusions can be performed on the even metal blank before the latter is formed to the bending cross member and joined in the way according to the invention. The metal blank can also be a tailored blank i.e. a tailor made metal sheet blank which is composed of or respectively, has different material qualities or metal sheet thicknesses. In praxis the use of tailor rolled blanks with different blank thicknesses is contemplated. Of course, the two hollow chambers can also be formed in longitudinal direction with cross sections which differ from one another and the component can be optimally adapted to different load situations.

In a further aspect of the invention in a bending cross member in the form of an impact cross member, the cross member has a height which varies along the longitudinal extension of the component in the vertical direction of the vehicle. The lower hollow chamber extends correspondingly offset upwards toward the center of the cross member, so that a lower height results in the center longitudinal sections compared to the height in the end region or respectively, in the connection region of the cross member. This course enables an optimal adjustment to impact scenarios in which a vertical offset is present between the connection plane of the impact cross member on one hand and the barrier on the other hand.

The motor vehicle bending cross member according to the invention is characterized by its efficient manufacturing and in particular by a lower weight. The motor vehicle bending cross member is configured one-layered. According to the invention one-layered means that the bending cross member is configured without doubling of material in which wall sections rest flat against one another. The formed legs only abut the metal blank in the joining region along their longitudinal edges and are joined there. The outer hollow chambers are spaced apart by the web.

As mentioned before, in an advantageous embodiment the hollow chambers have a cross section which varies along the longitudinal direction. Preferably the end sections of one or each chamber are tapered relative to a center longitudinal section of the respective hollow chamber.

With regard to manufacturing and application it is advantageous to provide mounting surfaces in the web. Mounting surfaces serve for fastening the motor vehicle bending cross member within the motor vehicle structure and/or for coupling the bending cross member with other or further components.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows in a schematic representation of the production of a motor vehicle bending cross member according to the invention;

FIGS. 2 and 3 show a first exemplary embodiment of a motor vehicle bending cross member according to the invention and the representation of an intermediate form (FIG. 2) and the final form (FIG. 3);

FIGS. 4 and 5 show a second exemplary embodiment of a motor vehicle bending cross member according to the invention with the representation of an intermediate form (FIG. 4) and the final form (FIG. 5);

FIG. 6 shows in a perspective representation a motor vehicle bending cross member according to the invention in the form of an impact cross member;

FIG. 7 shows the enlarged section of the end section of the motor vehicle bending cross member which is on the right in the image plane according to the representation of FIG. 6 and

FIG. 8 shows in a perspective representation a further embodiment of the motor vehicle bending cross member according to the invention in the form of a bumper cross member.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

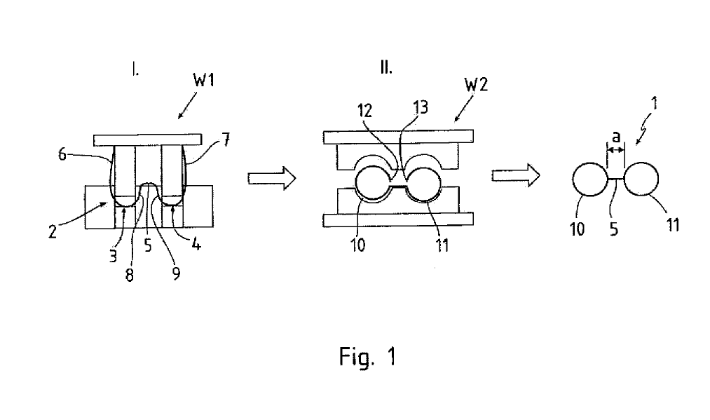

Turning now to the drawing, and in particular to FIG. 1, there is shown in a schematic representation the production of a motor vehicle bending cross member 1 according to the invention.

For producing a motor vehicle bending cross member 1 a metal blank is provided, which preferably already corresponds to the layout of the motor vehicle bending cross member 1 to be produced. The metal blank is formed in a press in a first tool W1 in a first forming or respectively pressing step I into a double U profile 2. The double-U-profile 2 has two U-shaped longitudinal sections 3, 4 which are connected by a web 5. It can be seen that the double-U-profile 2 is configured symmetrical to its center axis. The outer legs 6, 7 of the double-U-profile 2 are longer than the inner legs 8, 9 which are connected via the web 5.

After the double-U-profile 2 is formed, the outer legs 6, 7 or the U-shaped longitudinal sections 3, 4 are formed or respectively, re-formed in a second tool W2 in a further forming step II thereby forming hollow chambers 10, 11 in such a manner that the hollow chambers 10, 11 are spaced apart by the web 5, wherein the web 5 is configured one-layered. The longitudinal edges 12, 13 of the formed outer legs 6, 7 abut the metal blank in the region of the web 5 and are joined in the joining region, preferably by welding or bonding. The distance between the hollow chambers 10, 11 is defined by the width of the web 5 and in FIG. 1 is designated a.

The joining can be carried out over the entire length of the longitudinal edge 12, 13 or only partially section wise.

The two hollow chambers 10, 11 are spaced apart by the width a of the web 5. The width a of the web 5 can be adjusted to the specification of the components.

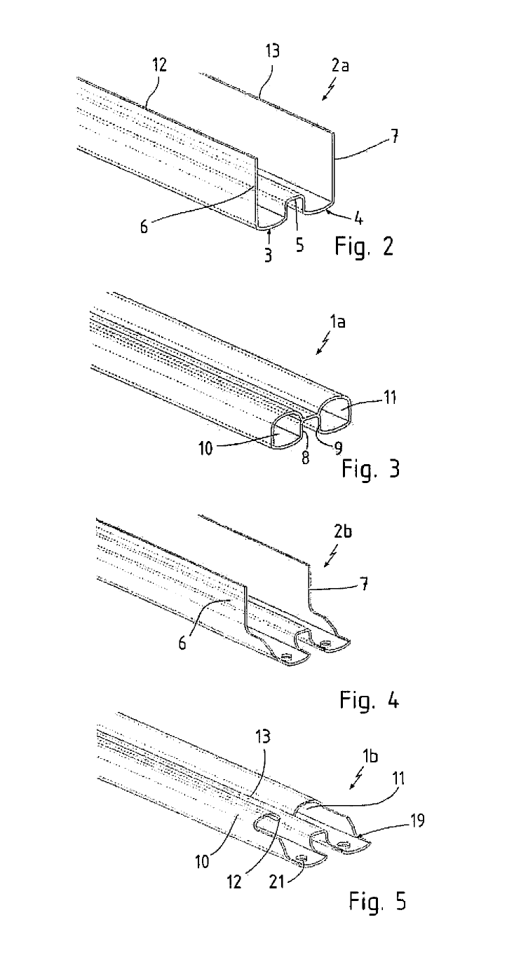

FIGS. 2 and 4 show embodiments of an intermediate product in the form of a double-U-profile 2a, 2b which is produced during the production of a motor vehicle bending cross member 1a, 1b. The double-U-profile 2b according to the representation of FIG. 4 was produced from a metal blank which is cut near-net-shape and punched.

FIGS. 3 and 5 show the motor vehicle bending cross member 1a, 1b produced according to the invention. The motor vehicle bending cross members 1a, 1b have a double hollow chamber profile with two outer hollow chambers 10, 11 which are connected by a web 5. The double hollow chamber profile is configured one-layered. A doubling of material in particular a doubling of material in the region of the web 5 by a two dimensional abutment of longitudinal sections of the double hollow chamber profile is not present. Only in the joining region of the longitudinal edge 12, 13 of the formed outer legs 6, 7 with the base body of the bending cross member 1a, 1b the latter contact one another and are joined there.

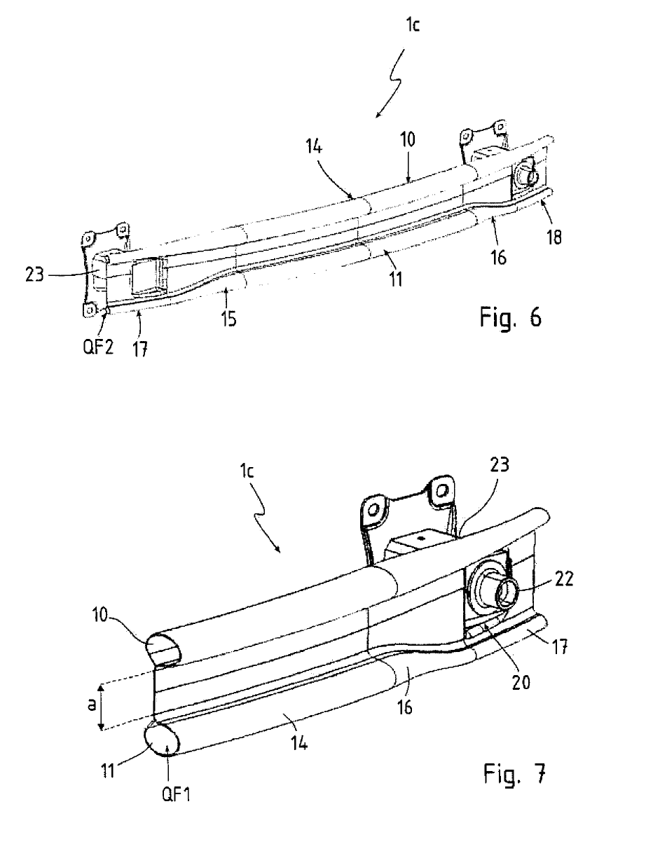

A motor vehicle bending cross member 1c in the form of a bumper cross member is shown in FIGS. 6 and 7. The motor vehicle bending cross member 1c has a one-layered double hollow chamber profile with two outer hollow chambers 10, 11, which are connected by a web 5 with the distance a. It can be seen that the hollow chambers 10, 11 have a cross section which varies along the longitudinal direction. The hollow chambers which extend over the entire length of the bending cross member 1c in longitudinal direction have a center longitudinal section 14 which transitions toward both of its ends into end sections 17, 18 via a continuously tapered intermediate section 15, 16. The hollow chambers 10, 11 of the center longitudinal section 14 each have a cross sectional surface QF1 which is greater than the cross sectional surface QF2 in the end sections 17, 18. The intermediate sections 15, 16 continuously change their cross sectional shape or respectively, cross sectional surface from the cross sectional surface QF1 to the cross sectional surface QF2.

The ratio of the cross sectional surface QF1 in the center longitudinal section 14 to the cross sectional surface QF2 in the end sections 17, 18 is 3:1. A cross sectional ratio of 2:1 and 1.5:1 is also advantageous.

The embodiments according to FIGS. 4 and 5 as well as FIGS. 6 and 7 show that mounting surfaces 19, 20 are provided in the web 5 of the motor vehicle bending cross member 1b, 1c. In the bending cross member 1b in the embodiment according to FIGS. 4 and 5 through openings 21 are introduced. The through openings 21 are produced by punching of the metal blank before the forming, in particular during cutting the blanks to size. The through openings 21 serve for fastening the bending cross member 1b within the door structure of a motor vehicle.

As can be seen in the motor vehicle bending cross member 1c according to the FIGS. 6 and 7, the mounting surface 20 serves for coupling of the motor vehicle bending cross member 1c with the crash boxes 23. Further, a mounting sleeve 22 for receiving or respectively, coupling of a towing eye is integrated.

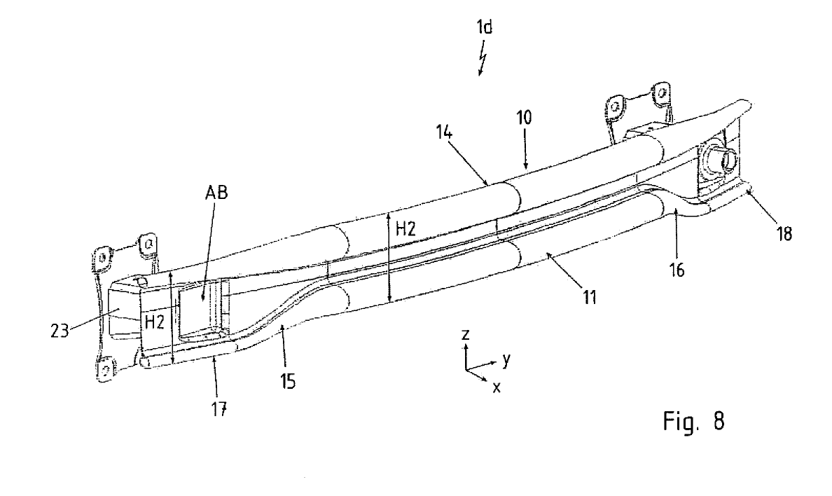

Finally, FIG. 8 shows a motor vehicle bending cross member 1d in the form of a further impact cross member. The motor vehicle bending cross member 1d differs from the bending cross member 1c according to the FIGS. 6 and 7 in that the bending cross member 1c or respectively, the double hollow chamber profile has a height which varies along a longitudinal extent of the component in the vertical direction Z of the vehicle. The lower hollow chamber 11 extends offset in positive Z direction toward the center of the bending cross member, so that a lower height H1 results in the end regions of the bending cross member 1d relative to the height H2. This course enables an optimal adjustment to impact scenarios in which a vertical offset between joining plane AB of the impact cross member on the one side and the barrier on the other side is present. In the shown exemplary embodiment the joining plane AB of the impact cross member 1d is lower in partial regions than the barrier, so that the impact cross member 1d can completely participate in the load bearing by the hollow chamber 11 which extends upwards in Z-direction.

Of course, both hollow chambers 10 and 11 can also have a height course which varies along their longitudinal direction in Z-direction.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a motor vehicle bending cross member from a metal blank comprising the steps of:
forming the metal blank into a double-U-profile, said double-U-profile having two U-shaped longitudinal sections connected by a web, each of said U-shaped longitudinal sections having outer and inner legs;
molding the outer legs of the U-shaped longitudinal sections to thereby form respective hollow chambers of the motor vehicle bending cross member, said hollow chambers extending along a longitudinal direction of the motor vehicle bending cross member; and
joining the outer legs to the motor vehicle bending cross member, such that the hollow chambers are spaced apart by the web and the web is configured one layered.

2. The method of claim 1 wherein the motor vehicle bending cross member is constructed as a door impact member or an impact cross member.

3. The method of claim 1, wherein the outer legs are longer than the inner legs.

4. The method of claim 1, wherein longitudinal edges of the outer legs are joined to the bending cross member.

5. The method of claim 1, wherein the outer legs are joined to the motor vehicle bending cross member in a region of the web.

6. The method of claim 1, wherein the bending cross member has a double-O-profiled cross section.

7. The method of claim 1, wherein each of the hollow chambers is formed to have a cross section which varies in a longitudinal direction of the hollow chamber.

8. The method of claim 1, further comprising before the forming step, cutting and/or punching the metal blank to near-net-shape.

9. A motor vehicle bending cross member comprising having a double hollow chamber profile comprising:
two outer hollow chambers, said outer hollow chambers being connected by a web, wherein the double hollow chamber profile is configured one-layered, and wherein the outer hollow chambers are spaced apart by the web.

10. The motor vehicle bending cross member of claim 9, wherein the hollow chambers have a cross section which varies in a longitudinal direction of the hollow chambers.

11. The motor vehicle bending cross member of claim 10, wherein one or each of the hollow chambers has end sections which are tapered relative to a center longitudinal section of the hollow chambers.

12. The motor vehicle bending cross member of claim 9, further comprising mounting surfaces in the web.
